(19) United States
(12) Patent Application Publication
(10) Pub. No.: US 2026/0127885 A1
(43) Pub. Date: May 7, 2026

(54) METHODS AND SYSTEM FOR AUTOMATICALLY IDENTIFYING ANOMALIES IN A VIDEO FEED

(71) Applicant: Honeywell International Inc., Charlotte, NC (US)

(72) Inventors: Deepika Sandeep, Bangalore (IN); Renil Austin Mendez, Kerala (IN); Vishwanath Gupta, Ranchi (IN)

(21) Appl. No.: 19/376,068

(22) Filed: Oct. 31, 2025

(30) Foreign Application Priority Data
Nov. 1, 2024 (IN) 202411083703

(51) Int. Cl. G06V 20/52; G06V 10/25; G06V 20/40; G06V 20/70; G10L 15/26

(52) U.S. Cl. CPC G06V 20/52; G06V 10/25; G06V 20/44; G06V 20/70; G10L 15/26

(57) ABSTRACT

Anomalies may be detected in a video feed that is captured by a video camera of a video surveillance system. At least part of the video feed may be fed to a Generative Multimodal Model (GMM) along with a prompt that prompts the GMM to look for anomalies occurring in at least part of the video feed. The video feed is processed by the GMM using the prompt to identify one or more anomalies occurring in the at least part of the video feed. The one or more anomalies identified by the GMM in at least part of the video feed are reported.

### CROSS-REFERENCE TO RELATED APPLICATIONS

This application claims priority pursuant to 35 U.S.C. 119(a) to India patent application No. 202411083703, filed Nov. 1, 2024, which application is incorporated herein by reference in its entirety.

### TECHNICAL FIELD

The present disclosure relates generally to video surveillance systems. More particularly, the present disclosure relates to automatically identifying anomalies in a video feed provided by a video surveillance system.

### BACKGROUND

Video surveillance systems can include a substantial number of video cameras, each of the video cameras producing video streams. In systems with hundreds or even thousands of video cameras, monitoring all of these video streams can be a daunting task. Having operators view all of the video streams can be an expensive, time-consuming process. What would be desirable are ways to use artificial intelligence to look for anomalies in the video feeds. What would be desirable are ways to automatically find anomalies and present the anomalies to an operator for confirmation without having to first train an AI model for each type of anomaly.

### SUMMARY

The present disclosure relates generally to video surveillance systems. More particularly, the present disclosure relates to automatically identifying anomalies in a video feed provided by a video surveillance system. An example may be found in a method for identifying anomalies occurring in a video feed that is captured by a video camera of a video surveillance system. The method includes receiving the video feed captured by the video camera of the video surveillance system and providing at least part of the video feed to a Generative Multimodal Model (GMM). A prompt is submitted to the GMM prompting the GMM to look for anomalies occurring in the at least part of the video feed. The video feed is processed by the GMM using the prompt to identify one or more anomalies occurring in the at least part of the video feed. The method includes reporting the one or more anomalies identified by the GMM in the at least part of the video feed.

Another example may be found in a video surveillance system. The video surveillance system includes a video camera that generates a video feed and a controller that is operatively coupled to the video camera. The controller is configured to receive the video feed captured by the video camera and to provide at least part of the video feed to a Generative Multimodal Model (GMM). The controller is configured to submit a prompt to the GMM prompting the GMM to look for anomalies occurring in the at least part of the video feed. The controller is configured to process the video feed with the GMM using the prompt to identify one or more anomalies occurring in the at least part of the video feed. The controller is configured to report the one or more anomalies identified by the GMM in the at least part of the video feed.

Another example may be found in a method for identifying anomalies occurring in a video feed that is captured by a video camera of a video surveillance system. The method includes receiving the video feed captured by the video camera of the video surveillance system and providing at least part of the video feed to a Vision Language Model (VLM). The VLM generates a text-based summarization of the at least part of the video feed. The text-based summarization of the at least part of the video feed is processed via a generative Large Language Model (LLM) to identify one or more anomalies occurring in the at least part of the video feed. The method includes reporting the one or more anomalies identified by the LLM.

The preceding summary is provided to facilitate an understanding of some of the innovative features unique to the present disclosure and is not intended to be a full description. A full appreciation of the disclosure can be gained by taking the entire specification, claims, figures, and abstract as a whole.

### BRIEF DESCRIPTION OF THE FIGURES

The disclosure may be more completely understood in consideration of the following description of various examples in connection with the accompanying drawings, in which:

FIG. 1 is a schematic block diagram showing an illustrative video surveillance system;

FIGS. 2A and 2B are flow diagrams that together show an illustrative method for identifying anomalies occurring in a video feed;

FIG. 3 is a flow diagram showing an illustrative method for identifying anomalies occurring in a video feed;

FIG. 4 is a schematic drawing showing an illustrative architecture for a frame-by-frame analysis algorithm;

FIG. 5 is a schematic drawing showing an illustrative architecture for video anomaly analysis;

FIG. 6 is a schematic drawing showing an illustrative example of video indexing and video log searching for specific video clips; and

FIG. 7 is a schematic drawing showing an illustrative example of a predictive maintenance use case using the architecture shown in FIG. 4.

While the disclosure is amenable to various modifications and alternative forms, specifics thereof have been shown by way of example in the drawings and will be described in detail. It should be understood, however, that the intention is not to limit the disclosure to the particular examples described. On the contrary, the intention is to cover all modifications, equivalents, and alternatives falling within the spirit and scope of the disclosure.

### DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

All numbers are herein assumed to be modified by the term “about”, unless the content clearly dictates otherwise. The recitation of numerical ranges by endpoints includes all numbers subsumed within that range (e.g., 1 to 5 includes 1, 1.5, 2, 2.75, 3, 3.80, 4, and 5).

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

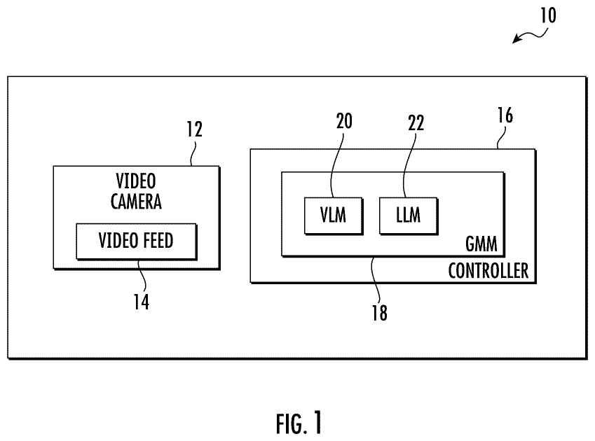

FIG. 1 is a schematic block diagram showing an illustrative video surveillance system 10. The illustrative video surveillance system 10 includes a video camera 12 that generates a video feed 14. While only a single video camera 12 is shown, it will be appreciated that the video surveillance system 10 may include any number of video cameras 12, and may for example includes tens, hundreds or even thousands of video cameras 12. The video surveillance system 10 includes a controller 16 that is operably coupled to the video camera 12. In some cases, the controller 16 may include or have access to a remotely-located GMM (Generative Multimodal Model) 18. In some cases, the GMM 18 may include (or have access to) a VLM (Vision Language Model) 20. In some cases, the GMM 18 may include (or have access to) an LLM (Large Language Model) 22.

The controller 16 is configured to receive the video feed 14 captured by the video camera 12 and to provide at least part of the video feed 14 to the GMM 18. The controller 16 is configured to submit a prompt to the GMM 18 that prompts the GMM 18 to look for anomalies occurring in the at least part of the video feed. The prompt may be general or specific, depending on the use case. The controller 16 is configured to process the video feed 14 with the GMM 18 using the prompt to identify one or more anomalies occurring in the at least part of the video feed 14, without having to first train an GMM 18 for each type of anomaly to be detected. In some cases, processing the video feed 14 by the GMM 18 using the prompt to identify one or more anomalies in the at least part of the video feed 14 includes the controller 16 generating a text-based summarization of the at least part of the video feed 14 using the VLM 20 of the GMM 18, followed by the controller 16 processing the text-based summarization using the generative LLM 22 of the GMM 18 to identify the one or more anomalies occurring in the at least part of the video feed 14. In some cases, the controller 16 may generate a text-based summarization for each of a plurality of frames (e.g., 20 frame video segment) of the at least part of the video feed 14 using the generative VLM 20 of the GMM 18. Example text based summarizations for each of ten (10) frames of an example video segment is show below:

### Frame 1

A middle-aged man, approximately 5′10″ tall, is walking across the parking lot. He wears a red hat that casts a shadow across his forehead and part of his nose. His facial expression is neutral, with relaxed eyebrows and a slight squint in his eyes from the sunlight. His lips are pressed together gently, suggesting a calm, focused demeanor. He wears a blue jacket, unzipped to mid-chest, with slight creases around the elbows and shoulders as he swings his arms. His faded jeans show wrinkles near his knees, and he is wearing brown leather shoes. His right foot is firmly planted at (x: 230, y: 400), while his left foot is lifted in mid-stride at (x: 245, y: 380). The gray asphalt beneath him is rough and cracked, with small fractures running diagonally from (x: 100, y: 450) to (x: 600, y: 300). Yellow parking lines appear on either side, approximately 100 pixels apart, faintly worn from use. A red sedan is parked about 15 feet away, with its front bumper visible at (x: 500, y: 590) and its windshield reflecting the bright sunlight. The glare on the windshield forms a bright spot at (x: 510, y: 580), and the car's body has small specks of dust visible along the side. The shadow of the car stretches eastward about 120 pixels from (x: 480, y: 590) to (x: 360, y: 600). To the left of the scene, a row of bushes sways gently in the breeze, with green leaves casting intricate shadows on the ground from (x: 10, y: 20) to (x: 100, y: 100). In the distance, a concrete wall forms the boundary of the parking lot, running horizontally across the frame at the top.

### Frame 2

The man continues his walk, now with his left foot lowered and planted on the ground at (x: 240, y: 385), while his right foot begins to lift off slightly at (x: 225, y: 395). His face shows a faint look of concentration, with his lips still closed but now slightly tighter as if in thought. His red hat sits squarely on his head, with a more pronounced shadow under its brim as the sun shifts. His blue jacket swings with his movement, with more defined wrinkles forming at the elbows. The jacket's material shimmers slightly in the sunlight, particularly around his left shoulder, where the light hits at an angle. The jeans show additional creases near the knees, and his brown shoes now scuff slightly against the asphalt. The ground beneath him is more visible, with the cracks in the asphalt appearing more prominent around (x: 110, y: 470). The yellow parking lines remain in place, though some faint tire tracks are now visible near his left foot, likely from a vehicle that passed recently. The red sedan remains parked, but the glare on the windshield has shifted slightly, now reflecting more sunlight at (x: 515, y: 585). A few dust particles are kicked up by the slight breeze and float near the rear of the car at (x: 510, y: 610). The car's shadow has shortened slightly to 115 pixels, from (x: 485, y: 595) to (x: 370, y: 600). The man's shadow, cast by the sun overhead, has also shortened slightly, now stretching 115 pixels from (x: 230, y: 400) to (x: 115, y: 460). The bushes to the left are swaying a bit more, their leaves reflecting sunlight and casting intricate shadows on the asphalt. The background concrete wall is now partially obscured by the movement of the leaves, with patches of sunlight shining through.

### Frame 3

The man's expression has tightened slightly, with his eyebrows furrowing just a bit as if he's thinking hard about something. His left foot is now fully grounded at (x: 245, y: 390), while his right foot is mid-air at (x: 225, y: 400), suggesting he is walking with purpose. The red hat on his head tilts slightly to the right as he turns his head slightly, casting a longer shadow across the left side of his face. The blue jacket sways gently, though a new wrinkle has appeared on his back due to the motion. His right hand remains in his jacket pocket, causing the jacket to pull slightly at his waist. His jeans are more wrinkled at the knees, especially on his left leg, which is more extended as he walks. A small gust of wind kicks up some dust from the ground, visible at (x: 250, y: 415) near his left shoe. The red sedan remains parked, but the sunlight reflecting off its windshield has intensified, forming a larger glare at (x: 520, y: 590). The car's shadow continues to shift as the sun moves slightly, now only 110 pixels long from (x: 480, y: 595) to (x: 365, y: 600). The man's shadow has also changed slightly, now stretching from (x: 225, y: 400) to (x: 110, y: 460). The bushes sway more noticeably, and a few leaves detach, drifting across the parking lot, some landing at (x: 150, y: 600). The sunlight filtering through the bushes creates dappled shadows on the concrete wall behind them.

### Frame 4

The man's expression shows a hint of determination, with his lips pressed together more tightly and his eyebrows furrowed further. His red hat is slightly askew due to the wind, though it still sits snugly on his head, with the shadow under the brim creating a deeper contrast on his face. His right foot is now fully lifted off the ground at (x: 210, y: 400), while his left foot is planted at (x: 235, y: 390). His blue jacket flutters slightly in the breeze, and the light catches on the zipper near his chest, causing a small reflection at (x: 270, y: 370). His right hand, still in his pocket, pulls the jacket fabric taut across his waist, creating a visible crease along his back. His jeans are more creased at the knees, with the right leg showing deeper folds as it bends mid-stride. The asphalt beneath him shows more detail, with a new crack visible at (x: 120, y: 480). The yellow parking lines remain unchanged, though faint tire marks are more prominent near his current position, at (x: 230, y: 390). The red sedan in the background is still parked, but the sunlight has shifted, and the glare on the windshield is now less intense, positioned at (x: 525, y: 595). A faint breeze blows more dust particles, which now collect near the car's rear bumper at (x: 505, y: 615). The car's shadow has shortened again, now measuring 105 pixels, from (x: 475, y: 590) to (x: 360, y: 600). The man's shadow also adjusts slightly, now stretching from (x: 230, y: 400) to (x: 110, y: 465). The bushes continue to sway in the breeze, with a few more leaves falling, and some of the shadows they cast shift further across the asphalt and onto the distant wall.

### Frame 5

The man's head is slightly turned to the left, and his facial expression shows more focus, his gaze directed toward something in the distance. His red hat has shifted just a fraction to the left, now casting a longer shadow across the right side of his face. His right foot is fully grounded at (x: 210, y: 405), while his left foot begins to lift at (x: 230, y: 395). The man's blue jacket has more pronounced folds along the arms, particularly on the left, as he swings his arm forward slightly. His right hand, still in his pocket, pulls the fabric tightly, causing the jacket to bunch slightly at his waist. The jeans are more visibly creased, particularly at the knees, and a faint scuff mark is visible on his right shoe. The asphalt beneath him has a more prominent crack visible at (x: 125, y: 470), running diagonally across the parking lot. The yellow parking lines remain in place, but a faint oil stain can now be seen near the man's left foot at (x: 220, y: 400). The red sedan in the background is still parked, though the glare on the windshield has shifted again, now reflecting sunlight more toward the upper corner at (x: 530, y: 595). The car's shadow continues to shift, now 100 pixels long, from (x: 470, y: 590) to (x: 355, y: 600). The man's shadow has adjusted slightly, now stretching from (x: 210, y: 405) to (x: 95, y: 470). The bushes to the left are still swaying in the wind, with more leaves falling, and their shadows stretch further across the parking lot, some reaching (x: 50, y: 600).

### Frame 6

The man has turned his head slightly more to the left, and his facial expression now reflects some level of concern, with his lips pursed and his eyebrows furrowed slightly. His red hat has settled back into place, with the shadow under the brim deepening on the right side of his face. His left foot is now fully lifted off the ground at (x: 220, y: 400), while his right foot remains firmly planted at (x: 205, y: 410). His blue jacket flutters slightly in the breeze, with the zipper now catching the light more prominently, reflecting at (x: 265, y: 380). The jacket pulls slightly across his back, creating deep folds along his waistline. His jeans are wrinkled more deeply at the knees, particularly on the right leg, as he shifts his weight forward. A faint scuff mark is visible on his left shoe, and the asphalt beneath him shows a more detailed crack pattern near his right foot at (x: 130, y: 475). The yellow parking lines remain consistent, though a new oil stain is visible at (x: 210, y: 405) near his right foot. The red sedan remains parked, though the glare on the windshield has diminished slightly, now reflecting less light at (x: 535, y: 600). The car's shadow continues to adjust, now measuring 95 pixels, from (x: 465, y: 590) to (x: 350, y: 600). The man's shadow also shifts, now stretching from (x: 205, y: 410) to (x: 90, y: 470). The bushes continue to sway, and more leaves fall onto the asphalt, some collecting near the curb at (x: 60, y: 600).

### Frame 7

The man's expression now appears slightly anxious, with his eyes widening and his lips parting just slightly, as though preparing to say something. His red hat remains in place, though the brim casts a more noticeable shadow across his right cheek. His right foot is now lifted at (x: 200, y: 415), while his left foot is firmly planted at (x: 215, y: 400). His blue jacket flutters more aggressively in the wind, and the zipper reflects more light at (x: 260, y: 375). A deep crease forms along the back of his jacket as he moves. His jeans are more creased at the knees, especially on his right leg, which is bent slightly as he walks. The asphalt beneath him shows more detailed cracks, particularly near his left foot at (x: 135, y: 475), and a faint oil stain is visible at (x: 215, y: 405). The red sedan remains parked, though the glare on the windshield has shifted slightly again, now reflecting sunlight at (x: 540, y: 600). The car's shadow continues to shorten, now only 90 pixels long, from (x: 460, y: 590) to (x: 345, y: 600). The man's shadow also shifts slightly, now stretching from (x: 200, y: 415) to (x: 85, y: 475). The bushes continue to sway, with more leaves falling, and some of the shadows they cast now stretch further across the parking lot, reaching (x: 55, y: 600).

### Frame 8

The man's expression has changed further, now looking more concerned as his lips part slightly, and his eyebrows remain furrowed. His red hat is still perched atop his head, though the shadow under the brim is less pronounced due to the shifting angle of the sun. His left foot is now mid-air at (x: 220, y: 395), while his right foot is firmly planted at (x: 205, y: 405). His blue jacket sways in the wind, and more wrinkles are visible along his sleeves. The zipper catches more light, reflecting at (x: 255, y: 375). His jeans are wrinkled more noticeably at the knees, and a faint scuff mark is visible on his right shoe. The asphalt beneath him shows more detail, with a deep crack visible near his right foot at (x: 140, y: 470). The yellow parking lines remain in place, though the oil stain near his left foot is more pronounced at (x: 215, y: 400). The red sedan remains parked, though the glare on the windshield has shifted slightly, now reflecting sunlight at (x: 545, y: 595). The car's shadow has shortened again, now measuring 85 pixels, from (x: 455, y: 590) to (x: 340, y: 600). The man's shadow has also shifted slightly, now stretching from (x: 205, y: 405) to (x: 90, y: 470). The bushes to the left continue to sway, with more leaves falling, and their shadows stretch further across the parking lot, some reaching (x: 60, y: 600).

### Frame 9

The man's expression has become more intense, with his lips parting further, as if he's about to call out. His red hat remains in place, though the shadow it casts across his face is more subdued. His left foot is now fully lifted at (x: 215, y: 395), while his right foot is firmly planted at (x: 205, y: 400). His blue jacket flutters in the wind, and the zipper catches the light more prominently, reflecting at (x: 250, y: 370). The jacket pulls slightly across his back, creating deep folds along his waistline. His jeans are more wrinkled at the knees, particularly on the right leg, which is bent slightly as he walks. The asphalt beneath him shows a more detailed crack pattern near his right foot at (x: 140, y: 470). The yellow parking lines remain consistent, though a new oil stain is visible at (x: 210, y: 405) near his right foot. The red sedan remains parked, though the glare on the windshield has diminished slightly, now reflecting less light at (x: 550, y: 590). The car's shadow continues to adjust, now measuring 80 pixels, from (x: 450, y: 590) to (x: 335, y: 600). The man's shadow also shifts, now stretching from (x: 205, y: 400) to (x: 85, y: 465). The bushes to the left continue to sway, with more leaves falling, and their shadows stretch further across the parking lot.

### Frame 10

The man has now turned his head slightly to the right, and his expression reflects concern, with his lips parted and his eyebrows furrowed slightly. His red hat remains on his head, though the shadow it casts across his face is more pronounced due to the sun's shifting position. His left foot is now fully lifted at (x: 210, y: 400), while his right foot remains firmly planted at (x: 205, y: 405). His blue jacket flutters in the wind, and the zipper catches more light, reflecting at (x: 245, y: 370). The jacket pulls slightly across his back, creating deep folds along his waistline. His jeans are wrinkled more deeply at the knees, particularly on the right leg, which is bent slightly as he walks. The asphalt beneath him shows a more detailed crack pattern near his right foot at (x: 135, y: 475). The yellow parking lines remain consistent, though a new oil stain is visible at (x: 210, y: 405) near his right foot. The red sedan remains parked, though the glare on the windshield has diminished slightly, now reflecting less light at (x: 545, y: 590). The car's shadow continues to adjust, now measuring 75 pixels, from (x: 445, y: 590) to (x: 330, y: 600).

The man's shadow also shifts, now stretching from (x: 210, y: 405) to (x: 95, y: 470). The bushes continue to sway, with more leaves falling, and their shadows stretch further across the parking lot, some reaching (x: 50, y: 600).

The controller 16 may process the text-based summarization for each of the plurality of frames of the at least part of the video feed 14 using the generative LLM 22 to identify the one or more anomalies occurring in the at least part of the video feed 14. This may be repeated for each of a plurality of video segments of the video feed 14. In some cases, the plurality of video segments may be rolling video segments that at least partially overlap one another in time. In some cases, the plurality of video segments may be sequential video segments that do not overlap one another in time.

In some cases, the controller 16 is configured to report the one or more anomalies identified by the GMM 18 in the at least part of the video feed 14. In some cases, the GMM 18 may be configured to identify one or more anomalies occurring in the at least part of the video feed 14 without requiring anomaly-specific training of the GMM 18 for each of the one or more anomalies identified by the GMM 18. In some cases, the GMM 18 may itself determine what is an anomaly and what is not an anomaly based on prior activity observed in prior video captured by the video camera 12. In some cases, an operator may manually confirm or deny an anomaly identified by the GMM 18, and the GMM 18 may use this information as input to the GMM 18 during subsequent analysis of the video feed captured by the video camera 12.

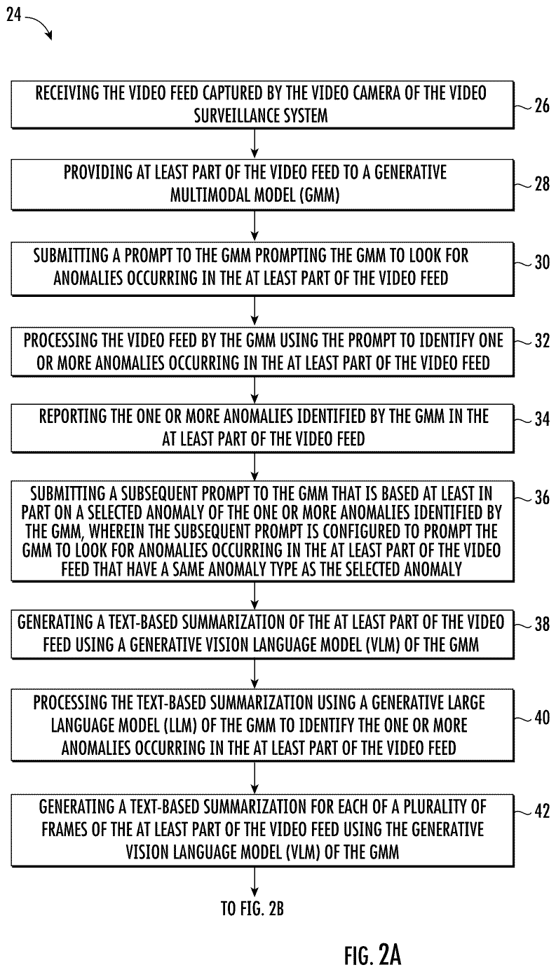

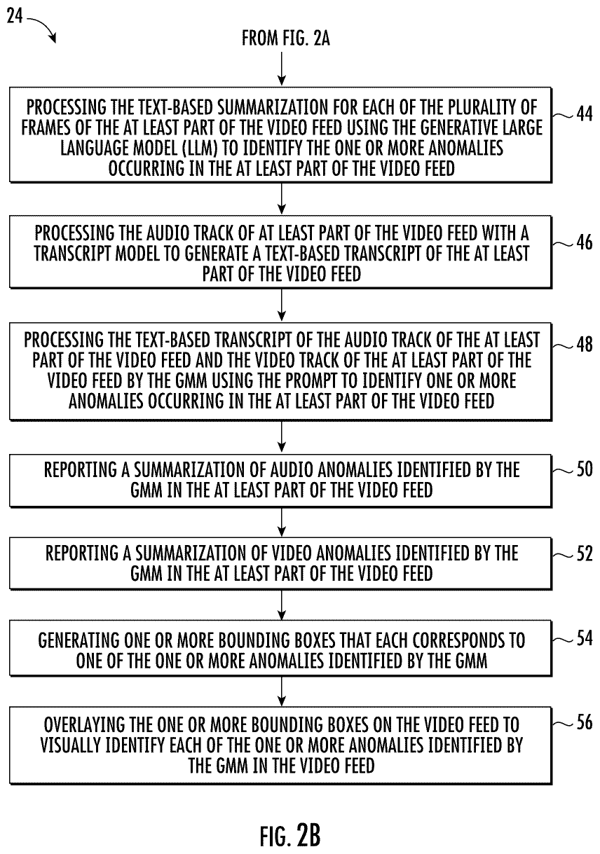

FIGS. 2A and 2B are flow diagrams that together show an illustrative method 24 for identifying anomalies occurring in a video feed (such as the video feed 14) that is captured by a video camera (such as the video camera 12) of a video surveillance system (such as the video surveillance system 10). The illustrative method 24 includes receiving the video feed captured by the video camera of the video surveillance system, as indicated at block 26. At least part of the video feed is provided to a Generative Multimodal Model (GMM), as indicated at block 28. A prompt is submitted to the GMM prompting the GMM to look for anomalies occurring in the at least part of the video feed, as indicated at block 30. In some cases, the prompt may be an anomaly generic prompt that prompts the GMM to look for any anomality determined by the GMM. In some cases, the prompt may be an anomaly specific prompt that prompts the GMM to look for a specific type or types of anomalies occurring in the at least part of the video feed.

The video feed is processed by the GMM using the prompt to identify one or more anomalies occurring in the at least part of the video feed, as indicated at block 32. In some cases, the GMM may identify one or more anomalies occurring in the at least part of the video feed without requiring anomaly specific training of the GMM for each of the one or more anomalies to be identified by the GMM. The one or more anomalies identified by the GMM in the at least part of the video feed are reported, as indicated at block 34. In some cases, the method 24 may include submitting a subsequent prompt to the GMM that is based at least in part on a selected anomaly of the one or more anomalies identified by the GMM, wherein the subsequent prompt is configured to prompt the GMM to look for anomalies occurring in the at least part of the video feed that have a same anomaly type as the selected anomaly (or would be related pre-cursor or post-cursor anomaly), as indicated at block 36.

In some cases, processing the video feed by the GMM using the prompt to identify one or more anomalies occurring in the at least part of the video feed may include, for example, generating a text-based summarization of the at least part of the video feed using a generative Vision Language Model (such as the VLM 20), as indicated at block 38, and then processing the text-based summarization using a generative Large Language Model (such as the LLM 22) to identify the one or more anomalies occurring in the at least part of the video feed, as indicated at block 40. In some instances, the VLM and LLM may be separate models. In some cases, the VLM and LLM may be an integrated model. In some cases, generating the text-based summarization of the at least part of the video feed may include generating the text-based summarization of a video clip or video segment that is extracted from the video feed and encompasses less than all of the video feed.

In some cases, the method 24 may include generating a text-based summarization for each of a plurality of frames of the at least part of the video feed using the generative VLM, as indicated at block 42. Continuing on FIG. 2B, the method 24 may include processing the text-based summarization for each of the plurality of frames of the at least part of the video feed using the generative LLM to identify the one or more anomalies occurring in the at least part of the video feed, as indicated at block 44.

In some cases, the video feed may include both an audio track and a video track. In some cases, the method 24 may include processing the audio track of at least part of the video feed with a transcript generation model that generates a text-based transcript of the at least part of the video feed, as indicated at block 46. The text-based transcript of the audio track of the at least part of the video feed and the video track of the at least part of the video feed may be processed by the GMM using the prompt to identify one or more anomalies occurring in the at least part of the video feed, as indicated at block 48.

In some cases, reporting the one or more anomalies identified by the GMM may include reporting a summarization of audio anomalies identified by the GMM in the at least part of the video feed, as indicated at block 50. In some cases, reporting the one or more anomalies identified by the GMM may include reporting a summarization of video anomalies identified by the GMM in the at least part of the video feed, as indicated at block 52.

In some cases, the method 24 may include generating one or more bounding boxes that each corresponds to one of the one or more anomalies identified by the GMM, as indicated at block 54. In some cases, the method 24 may include overlaying the one or more bounding boxes on the video feed to visually identify each of the one or more anomalies identified by the GMM in the video feed, as indicate at block 56.

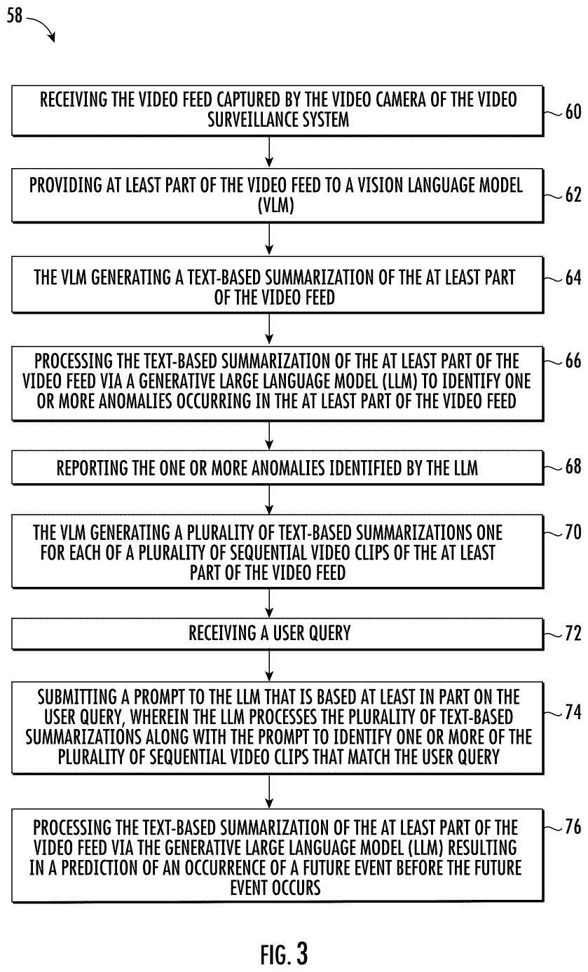

FIG. 3 is a flow diagram showing an illustrative method 58 for identifying anomalies occurring in a video feed (such as the video feed 14) that is captured by a video camera (such as the video camera 12) of a video surveillance system (such as the video surveillance system 10). The illustrative method 58 includes receiving the video feed captured by the video camera of the video surveillance system, as indicated at block 60. At least part of the video feed is provided to a Vision Language Model (such as the VLM 20), as indicated at block 62. The VLM generates a text-based summarization of the at least part of the video feed, as indicated at block 64. The text-based summarization of the at least part of the video feed is processed via a generative Large Language Model (such as the LLM 22) to identify one or more anomalies occurring in the at least part of the video feed, as indicated at block 66. The one or more anomalies identified by the LLM are reported, as indicated at block 68.

In some cases, the method 58 includes the VLM generating a plurality of text-based summarizations one for each of a plurality of sequential video clips or segments of the at least part of the video feed, as indicated at block 70. A user query may be received, as indicated at block 72. A prompt may be submitted to the LLM that is based at least in part on the user query, wherein the LLM processes the plurality of text-based summarizations along with the prompt to identify one or more of the plurality of sequential video clips that match the user query, as indicated at block 74. In some cases, the method 58 may include processing the text-based summarization of the at least part of the video feed via the generative Large Language Model (such as the LLM 22) resulting in a prediction of an occurrence of a future event before the future event occurs, as indicated at block 76.

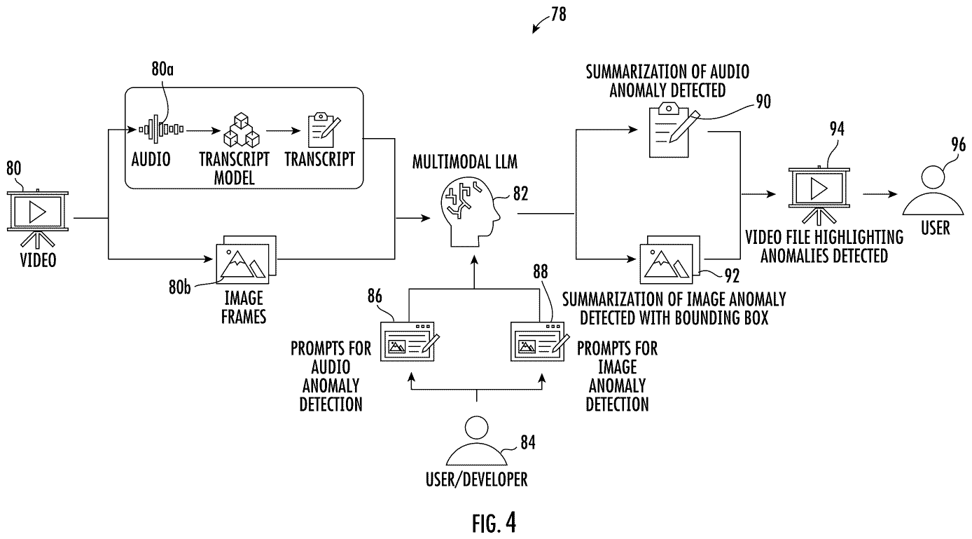

FIG. 4 is a schematic view of an illustrative architecture 78 that may be used in conducting a frame by frame analysis, which is one type of analysis architecture that is contemplated. A video 80 may be separated into audio 80a and video 80b and may be fed to a multimodal LLM (Large Language Model) 82. As shown, the audio portion of the video 80 may be processed to create a transcript model and ultimately a transcript. The video portion of the video 80 may be processed to obtain image frames. In some cases, it is the transcript and the image frames that may be provided to the LLM 82. The LLM 82 will receive prompts from a user 84, including prompts 86 for detecting audio anomalies and prompts 88 for detecting image anomalies. In some cases, the LLM 82 will output a summary 90 of detected audio anomalies and a summary 92 of detected image anomalies. The summary 90 and the summary 92 may be used to create a video file 94 that highlights the detected anomalies. The video file 94 may be provided to a user 96. In some cases, the user 96 may be the same as the user 84, although in some cases they may be different.

### Frame by Frame Analysis Example

| INPUT VIDEO FEED | PROMPT | OUTPUT |
|---|---|---|
| Fire seen | Identify if | Video feed with bounding |
| inside a | there are any | box showing fire location |
| room or zone | anomalies | along with notification to the |
| | observed. | user “FIRE DETECTED”. |
| A vehicle | Identify if | Video feed with bounding |
| has come | there are any | box showing static vehicle |
| to an | anomalies | location along with |
| unexpected | observed. | notification to user |
| stop | | “STOPPED VEHICLE |
| | | DETECTED”. |
| People | Provide a | Video feed showing the |
| walking | people count | people count per second of |
| through a | and flag it | the zone. If count >30 send |
| corridor in | as an anomaly | notification to user |
| a building | if the people | “OVERCROWDED”. |
| | count >30 | |
| People | People not | Video feed with bounding |
| wearing a | wearing a | box showing people without |
| mask in a | mask should | mask. Send total count and |
| hospital | be identified | notification to user “NOT |
| zone | as an anomaly. | WEARING MASK |
| | Provide a count | DETECTED”. |
| Overflowing | Overflowing | Video feed with bounding |
| waste bin | waste bin | box showing overflowing |
| | should be | waste bin along with |
| | identified as | notification to user |
| | an anomaly. | “IRREGULARITIES IN |
| | | WASTE MANAGEMENT” |

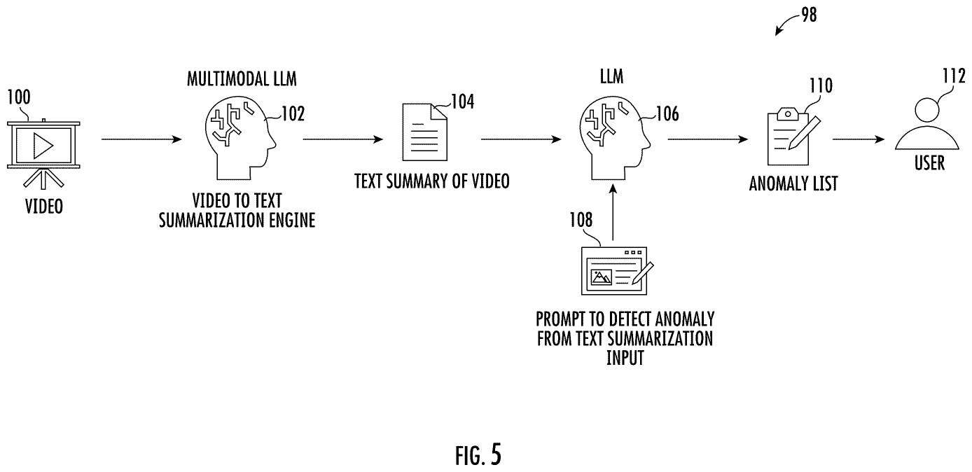

FIG. 5 is a schematic view of an illustrative architecture 98 that may be used in conducting a video anomaly analysis. The architecture 98 includes receiving a video 100. The video 100 may be provided to a multimodal LLM 102 that is configured to provide a text summary 104 of the video 100. The text summary 104 may be provided to an LLM 106 that is configured to provide an anomaly list 110, particularly in response to a prompt 108 to detect anomalies from the text summary 104. The anomaly list 110 is provided to a user 112.

### Video Anomaly Analysis Example

| INPUT | | |
|---|---|---|
| VIDEO | | |
| FEED | PROMPT | OUTPUT |
| A camera | Identify if | Detect a person who remains |
| feed pointed | there is any | in a restricted area for |
| towards a | anomaly | extended period of time |
| restricted | observed in | without engaging in any |
| area. | a defined | specific activity. |
| | restricted area. | |
| Security | Identify if | Video feed with bounding |
| camera in | there is any | box showing location of |
| railway | anomaly observed. | person in question, who has |
| station or | | shown an anomalous |
| airport. | | behavior. Timestamp is |
| | | highlighted. |
| Video feed | Detect a person | Person collapsed detected; |
| of a building | collapsing or | possible medical emergency, |
| area such as | falling, indicating | output includes bounding box |
| an office or | a possible | and timestamp. |
| a residential | medical emergency. | |
| area | | |
| A CCTV feed | Detect physical | Video feed with bounding |
| of a public | altercations or | box showing the people |
| or private | aggressive | involved or the region where |
| space. | behavior in | the altercation occurred. |
| | public spaces. | |
| Video feed | Identify vehicles that | Output will be a bounding |
| of a parking | suddenly accelerate in | box of the vehicle that |
| spot | pedestrian zones or | overspeeds in the pedestrian |
| entry/exit. | parking lots. | zone. |

In some cases, video anomaly analysis involves generation of metadata, as outlined below:

The proposed solution may leverage the power of multimodal analysis and large language models (LLMs) to automatically detect anomalies in CCTV footage without first having to train the model for each type of anomaly to be detected. Here's a breakdown of an illustrative process:

1. Video to Text Summarization:
1. Multimodal Analysis: The system processes the CCTV video, extracting both visual (objects, actions, movements) and audio (sounds, voices) information.
2. Textual Representation: This multimodal data is converted into a textual description, providing a comprehensive summary of the video content.

2. Anomaly Detection with LLM:
1. Textual Analysis: The generated text summary is fed into a large language model.
2. Anomaly Identification: The LLM, trained on vast amounts of text data, analyzes the summary and identifies any unusual or abnormal events or objects described within it.
3. Anomaly Listing: The system generates a list of detected anomalies, providing specific details about each.

3. Metadata Management:
1. Data Storage: Anomaly metadata can be stored in a database for later analysis, retrieval, or integration into other systems.
2. User Notification: Real-time or delayed notifications can be sent to users based on predefined anomaly types or severity levels.

This approach has a number of advantages, including:
Proactive Anomaly Detection: Unlike traditional methods that rely on specific prompts or predefined rules, this approach enables the system to autonomously identify a wide range of anomalies without explicit training/programming.
Enhanced Accuracy: By combining visual and audio information, the multimodal analysis provides a richer context for anomaly detection, leading to improved accuracy compared to solely image-based systems.
Scalability: The system can efficiently process and analyze large volumes of CCTV footage, making it suitable for large-scale deployments.
Actionable Insights: The generated anomaly list provides valuable information for security personnel, allowing them to prioritize investigations and respond effectively.
Data-Driven Optimization: By storing anomaly metadata, organizations can analyze trends over time and refine their security measures accordingly.

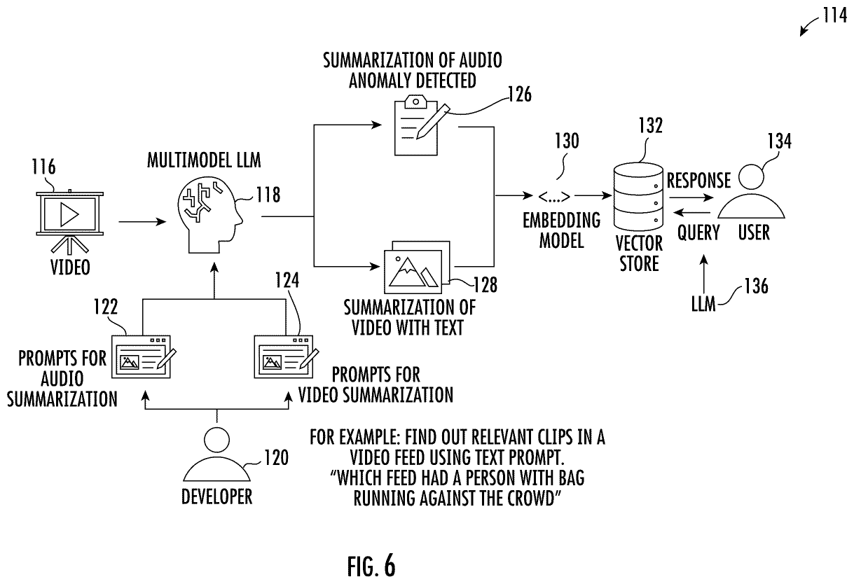

FIG. 6 is a schematic view of an illustrative video indexing example 114 in which summaries of small chunks/segments of a video feed are stored periodically, such as every two minutes. A video 116 is provided to a multimodal LLM 118. A developer 120 provides prompts 122 for audio summarization and/or prompts 124 for video summarization to the multimodal LLM 118. The multimodal LLM 118 may output a summary 126 of audio anomalies detected and/or a summary 128 of the video. The summary 126 and the summary 128 may be provided to an embedding model 130 that in turn communicates with a vector store 132 that receives user queries and provides responses to a user 134. In some cases, an LLM 136 may be involved in the exchanges with the user 134.

### Video Indexing Analysis Example

| INPUT QUERY | OUTPUT RESPONSE |
|---|---|
| For camera #12, did | Using the video feed data, 3 person were |
| anyone enter the | spotted in the area covered by camera 12. 2 of |
| area in past | them were present around 2 am and other at |
| 24 hours? | 6am. |
| Yesterday, someone | Camera 7 shows a person collapsing in front |
| collapsed in the | of reception area, The person was quickly |
| reception area, where | helped by others. It happened around 6:30 pm |
| and when did this | on Thursday. |
| happen? | |
| Looking for black car | A black car over-speeding can be seen in |
| over speeding, which | Camera 11 and Camera 6. |
| camera feed captured | This happened around 4:30pm on Friday. |
| it? | |
| Someone left door to | The door was left unlocked at 2:39 pm, here |
| IT area unlocked last | is the detail: |
| night, when did it | Camera 17, Time: 2:39 pm, Area: 5th Floor. |
| happen? | |
| Someone abandoned | Yes, a person wearing black jacket and blue |
| their bags in front of | jeans abandoned their bags in front of train. |
| train at platform 11, did | This happened around 6:13pm. |
| we capture who did it? | |

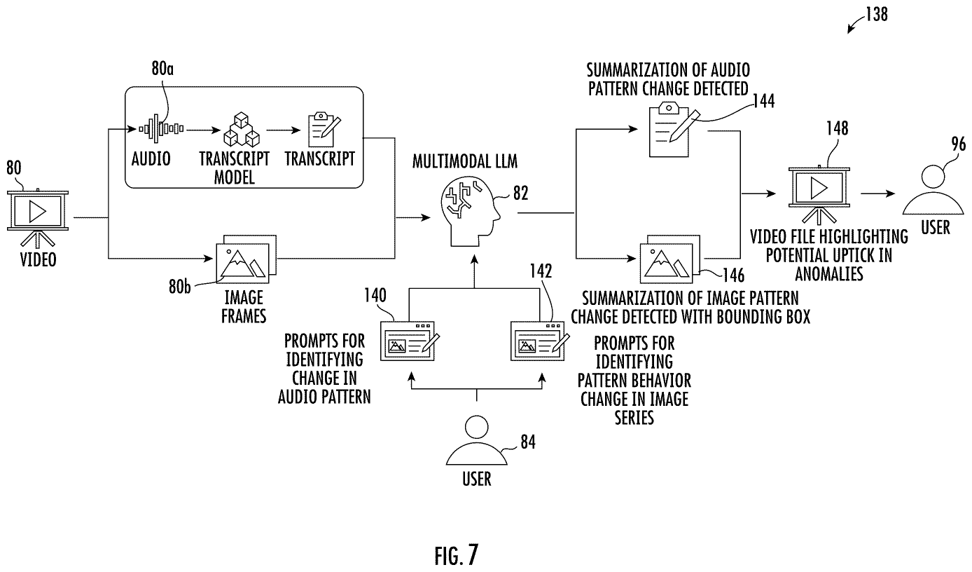

FIG. 7 is a schematic view of an illustrative example 138 of a predictive maintenance use case using the architecture 78 shown in FIG. 4. The user 84 may provide a prompt 140 for identifying changes in audio patterns. The user 84 may provide a prompt 142 for identifying changes in behavior patterns. The multimodal LLM 82 may output a summary 144 of detected changes in audio patterns and/or a summary 146 of identified changes in behavior patterns. A video file 148 highlights a possible uptick in anomalies, which is provided to the user 96.

### Predictive Maintenance Use Case Example

| INPUT VIDEO | | |
|---|---|---|
| FEED | PROMPT | OUTPUT |
| Monitoring unusual | Identify people | Video feed with bounding |
| activities or | gathering or | box showing the location of |
| behaviors, such | overcrowding | the people gathering along |
| as a sudden | than what's | with notification to the user: |
| gathering of | normally seen | “Potential Protest or Riot”. |
| people, which | in this zone as | This allows authorities to take |
| could indicate a | potential warning. | preventive measures. |
| potential protest | | |
| or riot. | | |
| Change in behavior | Identify unusual | Video feed with bounding |
| of vehicles and | pattern that | box showing the location of |
| pedestrians in | can cause | the abnormal pattern along |
| real-time, that | traffic | with notification to the user: |
| can lead to | congestion or | “Possible Traffic Congestion |
| potential | accidents. E.g. | Warning”. This can help |
| traffic | Driving on wrong | traffic management centers to |
| congestion | side, lead to | adjust traffic signals, reroute |
| or accidents. | traffic being | traffic, or dispatch emergency |
| | slow or accident. | services in advance. |
| | Pipe broken that | |
| | would cause traffic | |
| | to slow. Weather - | |
| | snow | |
| Monitor the | If streetlights | Video feed with bounding |
| functioning of | are seen | box showing the location of |
| the streetlights. | flickering, | the streetlights flickering |
| | identify it as | along with notification to the |
| | possible repair | user: “Possible Streetlight |
| | case. | Repair Work Needed”. |
| Observing belt | Identify belt | Belt slippage detected in |
| slippage in | slippage in | mechanical system; belt |
| mechanical | machinery, | replacement advised. |
| systems. | which could | |
| | indicate | |
| | worn-out belts | |
| | or misalignment. | |
| | Identify signs | |
| | of overheating | |
| | such as | |
| | discoloration | |
| | or smoke in | |
| | electrical panels | |
| | or circuit boards. | |
| Detecting | | Overheating detected in |
| overheating in | | electrical panel; potential |
| electrical panels | | circuit overload. |

Having thus described several illustrative embodiments of the present disclosure, those of skill in the art will readily appreciate that yet other embodiments may be made and used within the scope of the claims hereto attached. It will be understood, however, that this disclosure is, in many respects, only illustrative. Changes may be made in details, particularly in matters of shape, size, arrangement of parts, and exclusion and order of steps, without exceeding the scope of the disclosure. The disclosure's scope is, of course, defined in the language in which the appended claims are expressed.

What is claimed is:

1. A method for identifying anomalies occurring in a video feed that is captured by a video camera of a video surveillance system, the method comprising:
receiving the video feed captured by the video camera of the video surveillance system;
providing at least part of the video feed to a Generative Multimodal Model (GMM);
submitting a prompt to the GMM prompting the GMM to look for anomalies occurring in the at least part of the video feed;
processing the video feed by the GMM using the prompt to identify one or more anomalies occurring in the at least part of the video feed; and
reporting the one or more anomalies identified by the GMM in the at least part of the video feed.

2. The method of claim 1, wherein the GMM identifies one or more anomalies occurring in the at least part of the video feed without requiring anomaly specific training of the GMM for each of the one or more anomalies identified by the GMM.

3. The method of claim 1, wherein the prompt is an anomaly generic prompt that prompts the GMM to look for any anomaly determined by the GMM.

4. The method of claim 1, wherein the prompt is an anomaly specific prompt that prompts the GMM to look for a specific type of anomaly occurring in the at least part of the video feed.

5. The method of claim 1, further comprising:
submitting a subsequent prompt to the GMM that is based at least in part on a selected anomaly of the one or more anomalies identified by the GMM, wherein the subsequent prompt is configured to prompt the GMM to look for anomalies occurring in the at least part of the video feed that have a same anomaly type as the selected anomaly.

6. The method of claim 1, wherein processing the video feed by the GMM using the prompt to identify one or more anomalies occurring in the at least part of the video feed comprises:
generating a text-based summarization of the at least part of the video feed using a generative Vision Language Model (VLM) of the GMM; and
processing the text-based summarization using a generative Large Language Model (LLM) of the GMM to identify the one or more anomalies occurring in the at least part of the video feed.

7. The method of claim 6, wherein the VLM and LLM are separate models.

8. The method of claim 6, wherein the VLM and LLM are an integrated model.

9. The method of claim 6, wherein generating the text-based summarization of the at least part of the video feed comprises generating the text-based summarization of a video clip that is extracted from the video feed and encompasses less than all of the video feed.

10. The method of claim 6, comprising:
generating a text-based summarization for each of a plurality of frames of the at least part of the video feed using the generative Vision Language Model (VLM) of the GMM; and
processing the text-based summarization for each of the plurality of frames of the at least part of the video feed using the generative Large Language Model (LLM) to identify the one or more anomalies occurring in the at least part of the video feed.

11. The method of claim 1, wherein the video feed includes an audio track and a video track, the method comprising:
processing the audio track of at least part of the video feed with a transcript model to generate a text-based transcript of the at least part of the video feed; and
processing the text-based transcript of the audio track of the at least part of the video feed and the video track of the at least part of the video feed by the GMM using the prompt to identify one or more anomalies occurring in the at least part of the video feed.

12. The method of claim 11, where reporting the one or more anomalies identified by the GMM comprises:
reporting a summarization of audio anomalies identified by the GMM in the at least part of the video feed; and
reporting a summarization of video anomalies identified by the GMM in the at least part of the video feed.

13. The method of claim 1, comprising:
generating one or more bounding boxes that each corresponds to one of the one or more anomalies identified by the GMM; and
overlaying the one or more bounding boxes on the video feed to visually identify each of the one or more anomalies identified by the GMM in the video feed.

14. A video surveillance system comprising:
a video camera that generates a video feed;
a controller operatively coupled to the video camera, the controller configured to:
receive the video feed captured by the video camera;
provide at least part of the video feed to a Generative Multimodal Model (GMM);
submit a prompt to the GMM prompting the GMM to look for anomalies occurring in the at least part of the video feed;
process the video feed with the GMM using the prompt to identify one or more anomalies occurring in the at least part of the video feed; and
report the one or more anomalies identified by the GMM in the at least part of the video feed.

15. The video surveillance system of claim 14, wherein the GMM is configured to identify one or more anomalies occurring in the at least part of the video feed without requiring anomaly specific training of the GMM for each of the one or more anomalies identified by the GMM.

16. The video surveillance system of claim 14, wherein processing the video feed by the GMM using the prompt to identify one or more anomalies occurring in the at least part of the video feed comprises:
the controller generating a text-based summarization of the at least part of the video feed using a generative Vision Language Model (VLM) of the GMM; and
the controller processing the text-based summarization using a generative Large Language Model (LLM) of the GMM to identify the one or more anomalies occurring in the at least part of the video feed.

17. The video surveillance system of claim 16, comprising:
the controller generating a text-based summarization for each of a plurality of frames of the at least part of the video feed using the generative Vision Language Model (VLM) of the GMM; and
the controller processing the text-based summarization for each of the plurality of frames of the at least part of the video feed using the generative Large Language Model (LLM) to identify the one or more anomalies occurring in the at least part of the video feed.

18. A method for identifying anomalies occurring in a video feed that is captured by a video camera of a video surveillance system, the method comprising:
receiving the video feed captured by the video camera of the video surveillance system;
providing at least part of the video feed to a Vision Language Model (VLM);
the VLM generating a text-based summarization of the at least part of the video feed;
processing the text-based summarization of the at least part of the video feed via a generative Large Language Model (LLM) to identify one or more anomalies occurring in the at least part of the video feed; and
reporting the one or more anomalies identified by the LLM.

19. The method of claim 18, wherein:
the VLM generating a plurality of text-based summarizations one for each of a plurality of sequential video clips of the at least part of the video feed;
receiving a user query; and
submitting a prompt to the LLM that is based at least in part on the user query, wherein the LLM processes the plurality of text-based summarizations along with the prompt to identify one or more of the plurality of sequential video clips that match the user query.

20. The method of 18, comprising processing the text-based summarization of the at least part of the video feed via the generative Large Language Model (LLM) resulting in a prediction of an occurrence of a future event before the future event occurs.
